(19) United States
(12) Patent Application Publication
(10) Pub. No.: US 2004/0107228 A1
(43) Pub. Date: Jun. 3, 2004

(54) Method having summary function for calculator

(75) Inventors: Ming Wei Chuang, Taipei (TW); Ming Chih Chen, Taipei (TW)

Correspondence Address: BROWDY AND NEIMARK, P.L.L.C., 624 NINTH STREET, NW, SUITE 300, WASHINGTON, DC, 20001-5303, US

(73) Assignee: Kinpo Electronics, Inc., Taipei (TW)

(21) Appl. No.: 10/307,344

(22) Filed: Dec. 2, 2002

(51) Int. Cl. G06F 3/00

(52) U.S. Cl. 708/160

(57) ABSTRACT

A method having a summary function for a calculator is proposed. The method is matched with the operation of software program to let the calculator have both the functions of accounts check and surplus calculation. First, data of the desired items selectively recorded by the user are stored in a memory. A summary mode is then entered into to check each piece of subtotal data one by one for use of accounting of one day or one week. Moreover, each piece of data in the memory can be summed up. Thereby, the convenience in use of the calculator can be enhanced for stores or shop employees.

### FIELD OF THE INVENTION

The present invention relates to a method having a summary function for a calculator and, more particularly, to a method capable of letting a calculator have both the functions of accounts check and surplus calculation.

### BACKGROUND OF THE INVENTION

The functions of existent calculators are limited to recording a certain piece of subtotal and the total sum of direct summation or direct subtraction (e.g., M+, M− and so on). If a common store wants to selectively record a certain piece of subtotal data to facilitate check of each piece of result one by one, or wants to sum up for use of accounting or surplus statistics of one day or one week, there is no existent calculator having the suitable function.

There is also one kind of commercially available calculators capable of recording all the operation processes of a user. However, they cannot let the user record only the desired items and perform summary and calculation. Moreover, they will consume much memory capacity for recording all the calculation processes, hence increasing the cost. If the user only wants to know each piece of subtotal and calculate the surplus without the need of checking the calculation processes, the above calculators are not applicable. Accordingly, the present invention designs a method capable of letting a calculator have both the functions of accounts check and surplus calculation.

### SUMMARY OF THE INVENTION

One object of the present invention is to provide a method capable of letting a calculator have both the functions of accounts check and surplus calculation, whereby a user can selectively record data of the desired items and store them into a memory so that the user can enter into a summary mode to check each piece of data one by one for use of accounting of one day or one week. Moreover, each piece of data in the memory can be summed up. Thereby, the user can have both the functions of accounts check and surplus calculation with the memory space used most economically, hence enhancing the convenience of use.

To achieve the above object, the present invention provides a method capable of letting a calculator have both the functions of accounts check and surplus calculation, wherein software program, inputted temporary calculation data and data of the desired items selectively recorded by the user are stored in a memory of the calculator, and a key for a summary function is matched so that the user can enter into a summary mode to check each piece of subtotal data one by one for use of accounting. Moreover, each piece of data in the memory can be summed up.

The various objects and advantages of the present invention will be more readily understood from the following detailed description when read in conjunction with the appended drawing, in which:

### BRIEF DESCRIPTION OF THE DRAWINGS

FIG. 1 is an architecture diagram of a calculator of the present invention;

FIG. 2 is a perspective view of a calculator of the present invention;

FIG. 3 is a flowchart for saving summary data of the present invention;

FIG. 4 is a flowchart for clearing data of the present invention;

FIG. 5 is a flowchart for switching the summary and calculation modes of the present invention;

FIG. 6 is a flowchart for data inquiry of the present invention;

FIG. 7 is a flowchart for clearing data one by one and confirming data of the present invention;

FIG. 8 is a flowchart for inserting items of the present invention; and

FIG. 9 is a flowchart for data summary and printing of the present invention.

### DETAILED DESCRIPTION OF THE PREFERRED EMBODIMENTS

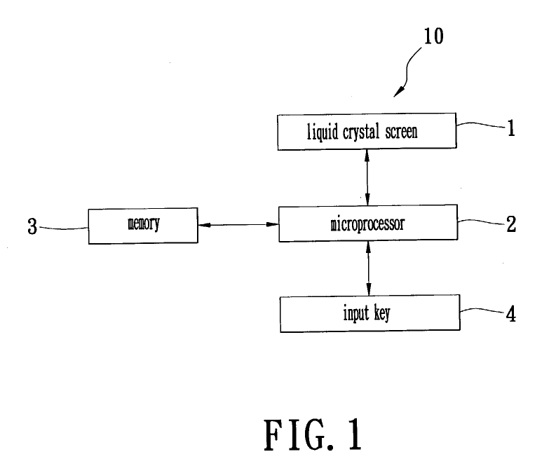

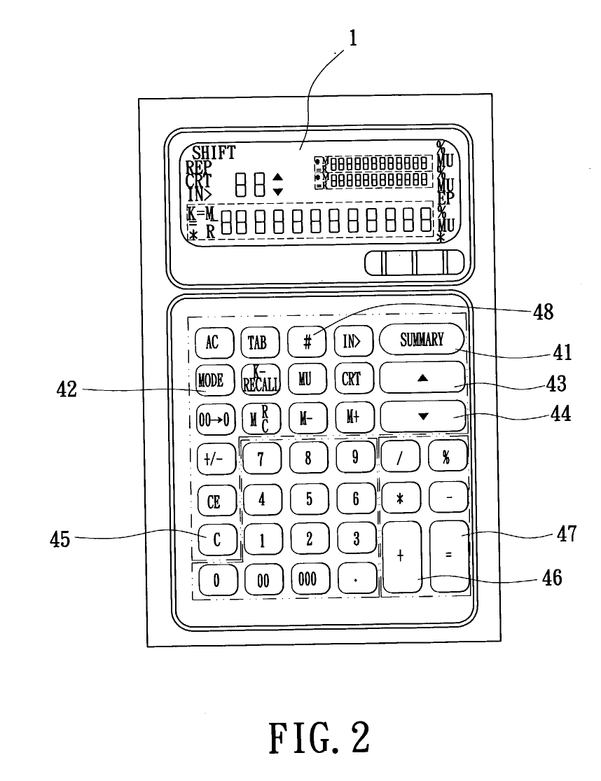

As shown in FIG. 1, a calculator of the present invention comprises a liquid crystal screen 1, a microprocessor 2, a memory 3, and input keys 4. The liquid crystal screen 1 is used for looking up of user. The microprocessor 2 is used to process and operate data. The memory is used to store software program used by the calculator, inputted temporary calculation data and data of the desired items selectively recorded by an operator. The input keys 4 are used for data input of user. The input keys 4 have a key set for performing the summary function provided for the operator. The key set comprises a summary key 41, a mode key 42, inquiry keys (↑, ↓) 43 and 44, a clear key (C) 45, an insertion key (+) 46, a data summary operation key (=) 47, and a print key 48, as shown in FIG. 2.

The user can arbitrarily select data of the desired item and store it into the memory 3 so that the user can enter into a summary mode to check each piece of subtotal data one by one for use of accounting of: one day or one week. Moreover, he can sum up each piece of data in the memory 3. Thereby, the user can have both the functions of accounts check and surplus calculation with the memory space used most economically, hence enhancing the convenience of use. The above summary key 41 has the following functions.

1. When the user wants to record a piece of subtotal data, pressing of this key will record the present data into the memory, and a summary icon will be displayed on the liquid crystal screen, representing there is data stored in the memory.

2. When the user wants to clear all data in the memory, he first presses the mode key to enter into the summary mode and then presses the summary key for 3 seconds to perform the operation of complete clearing.

3. After entering into the summary mode, the item will be displayed before each piece of data to facilitate inquiry of user.

The above mode key 42 has the following functions.

1. It is used to switch between a calculation mode and the summary mode.

2. When entering into the summary mode, the summary icon on the liquid crystal screen will continually blink to inform the user.

3. When the user enters into the summary mode for the first time, the first piece of data will be displayed. After leaving and entering into the summary mode again, the displayed item will be the item displayed at the previous time he leaves the summary mode. Therefore, if the user finds there is doubt about a certain piece of data, he can first switch to the calculation mode for calculation again and then switch back to the summary mode for double check.

The above inquiry keys 43 and 44 have the following function:

In the summary mode, these two keys can be used to inquire each piece of data up and down.

The above clear key (C) 45 has the following function:

In the summary mode, the displayed piece of data will be cleared.

The above insertion key (+) 46 has the following function:

In the summary mode, an item can be inserted in front of the currently displayed item. After data input, this piece of inserted data will be recorded into the memory when leaving this item or directly leaving the summary mode.

The above summary operation key (=) 47 has the following function:

In the summary mode, all recorded data will be summed up and the result will be displayed on the liquid crystal screen.

The above print key (#) 48 has the following function:

In the summary mode, when this key is pressed, each piece of subtotal data and the calculated total sum (this function is only limited to a print mode) will be printed one by one.

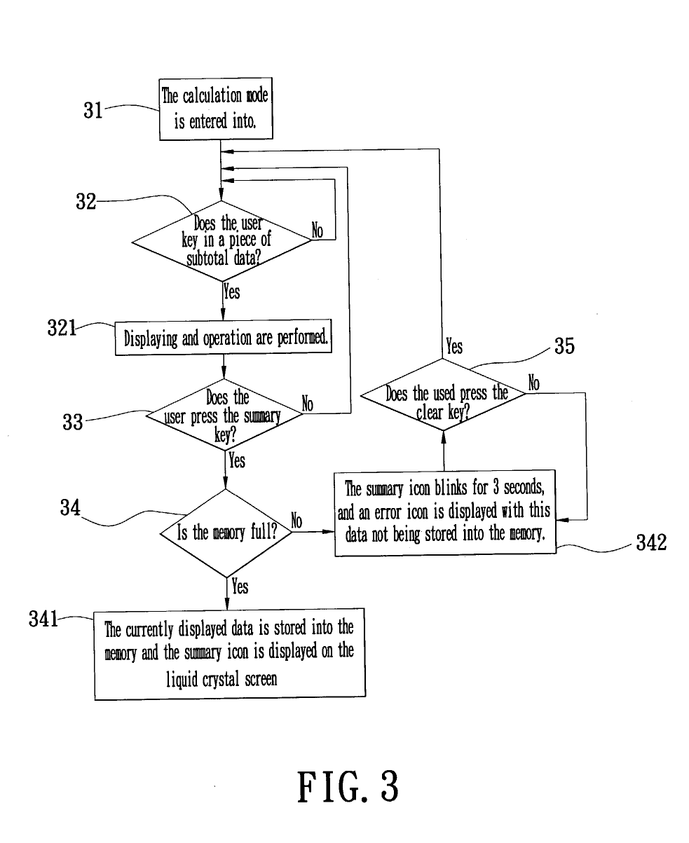

FIG. 3 is a flowchart of save summary data of the present invention.

Step 31: The calculation mode is entered into.

Step 32: Whether the user keys in a subtotal data is determined. If the answer is negative, this step is repeated; otherwise, Step 321 is jumped to for displaying and operating this data and then Step 33 is jumped to.

Step 33: Whether the user presses the summary key is determined. If the answer is negative, Step 32 is jumped back to; otherwise, Step 34 is jumped to.

Step 34: Whether the memory is full is determined. If the answer is negative, Step 341 is jumped to for recording the currently displayed data into the memory and displaying the summary icon on the liquid crystal screen; otherwise, Step 342 is jumped to for blinking the summary icon for 3 seconds and displaying an error icon with this data not being stored into the memory. Step 35 is then jumped to.

Step 35: Whether the clear key is to be keyed in to clear all data in the memory is determined. If the answer is positive, Step 32 is jumped back to; otherwise, Step 342 is jumped to.

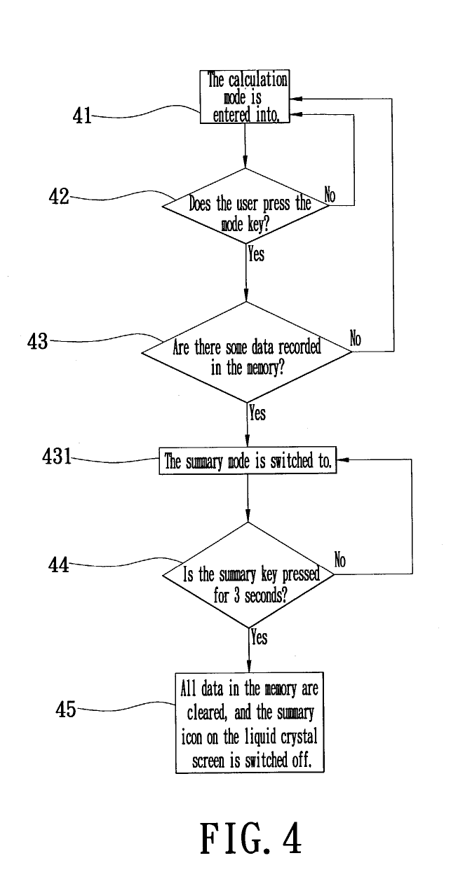

FIG. 4 is a flowchart for clearing data of the present invention.

Step 41: The calculation mode is entered into.

Step 42: Whether the user presses the mode key is determined. If the answer is negative, Step 41 is jumped back to; otherwise, Step 43 is jumped to.

Step 43: Whether there are some data recorded in the memory is determined. If the answer is negative, Step 41 is jumped back to; otherwise, Step 431 is jumped to for entering into the summary mode and Step 44 is then jumped to.

Step 44: Whether the summary key is pressed for 3 seconds is determined. If the answer is negative, Step 431 is jumped back to; otherwise, Step 45 is jumped to for clearing all data in the memory and switching off the summary icon on the liquid crystal screen.

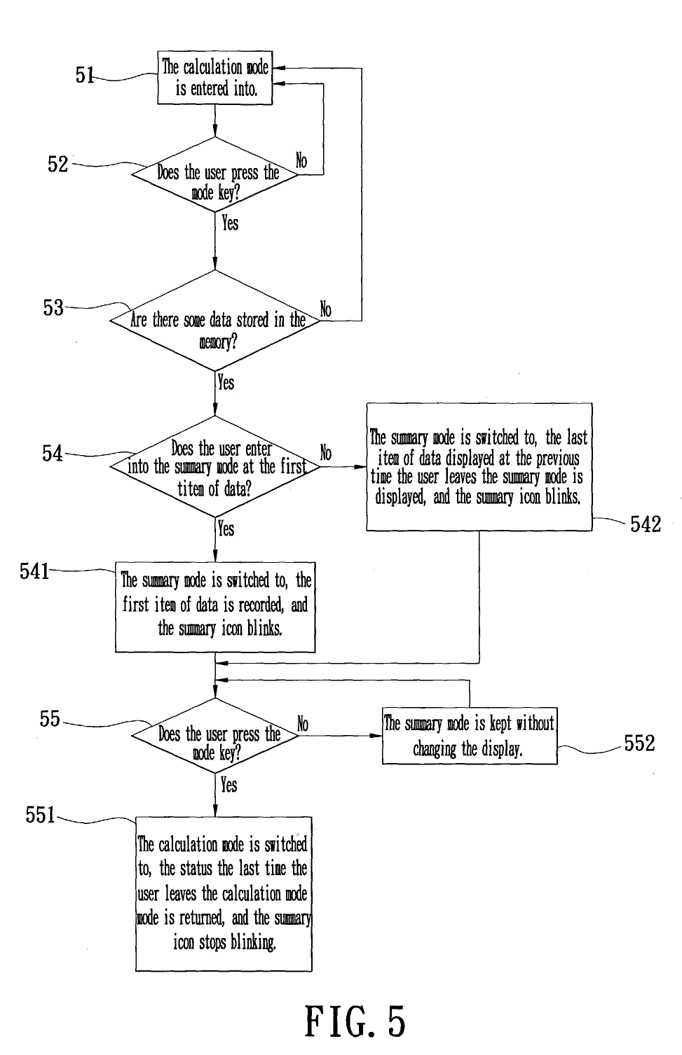

FIG. 5 is a flowchart for switching between the summary and calculation modes of the present invention.

Step 51: The calculation mode is entered into.

Step 52: Whether the user presses the mode key is determined. If the answer is negative, Step 51 is jumped back to; otherwise, Step 53 is jumped to.

Step 53: Whether there are some data stored in the memory is determined. If the answer is negative, Step. 51 is jumped back to; otherwise, Step 54 is jumped to.

Step 54: Whether the user enters into the summary mode at the first item of data is determined. If the answer is positive, Step 541 is jumped to for switching to the summary mode, displaying this item of data and blinking the summary icon, and Step 55 is then jumped to; otherwise, Step 542 is jumped to for switching to the summary mode, displaying an item of data displayed at the previous time he leaves the summary mode and blinking the summary icon, and Step 55 is then jumped to.

Step 55: Whether the user presses the mode key is determined. If the answer is positive, Step 551 is jumped to for switching to the calculation mode, returning to the status the last time he leaves the calculation mode and stopping blinking the summary icon; otherwise, Step 552 is jumped to for keeping at the summary mode without changing the display.

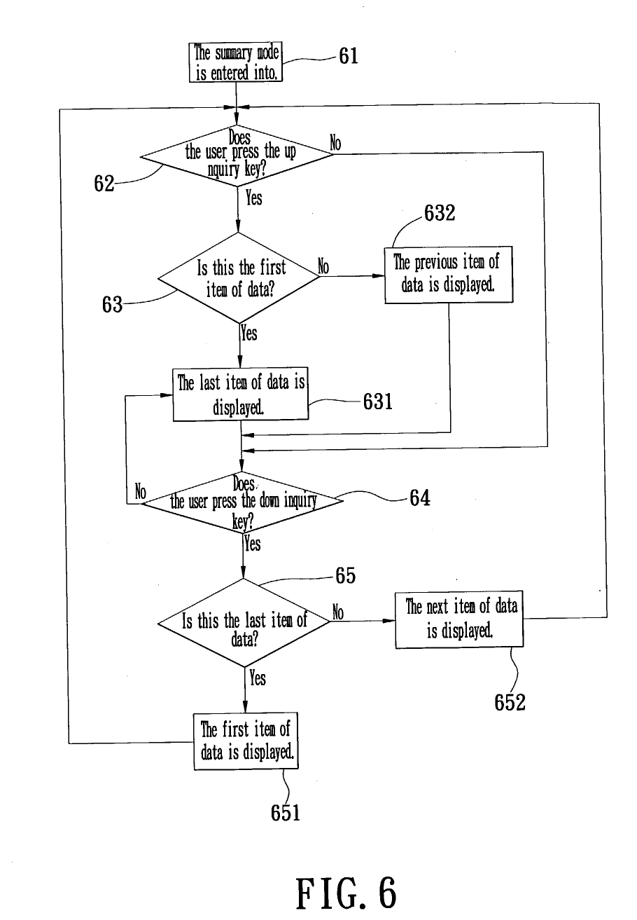

FIG. 6 is a flowchart for data inquiry of the present invention.

Step 61: The summary mode is entered into.

Step 62: Whether the user presses the up inquiry key is determined. If the answer is negative, Step 64 is jumped to; otherwise, Step 63 is jumped to.

Step 63: Whether this is the first item of data is determined. If the answer is positive, Step 631 is jumped to for displaying the last item of data, and Step 64 is jumped to; otherwise, Step 632 is jumped to for displaying the previous item of data, and Step 64 is then jumped to.

Step 64: Whether the user presses the down inquiry key is determined. If the answer is negative, Step 631 is jumped back to; otherwise, Step 65 is jumped to.

Step 65: Whether this is the last item of data is determined. If the answer is positive, Step 651 is jumped to for displaying the first item of data, and Step 62 is then jumped back to; otherwise, Step 652 is jumped to for displaying the next item of data, and Step 62 is then jumped back to.

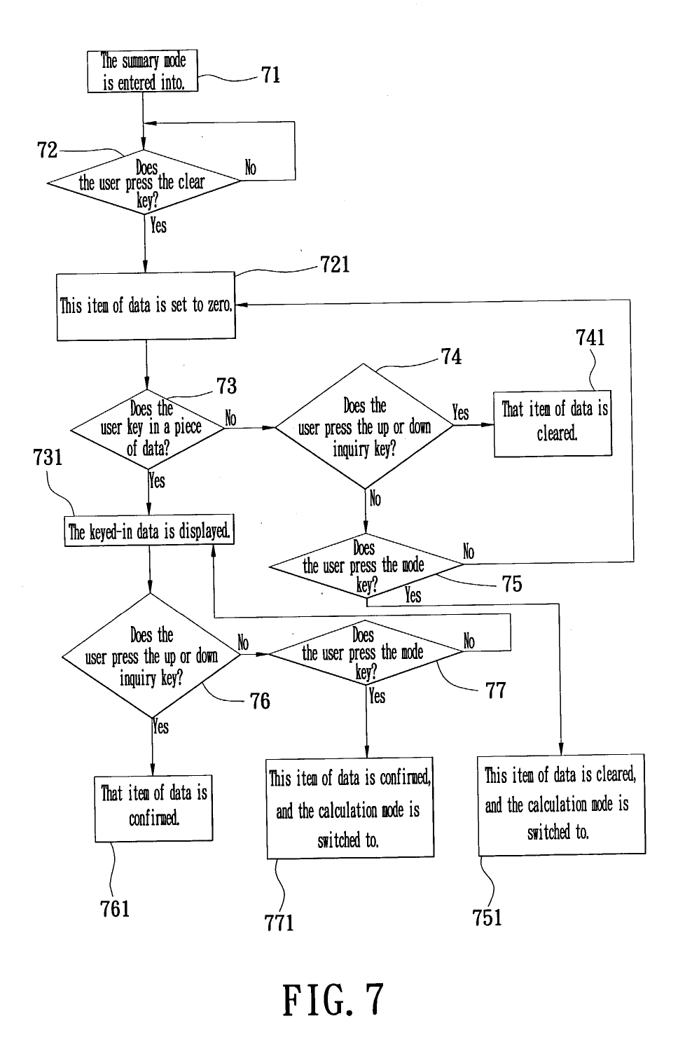

FIG. 7 is a flowchart for clearing data one by one and confirming data of the present invention.

Step 71: The summary mode is entered into.

Step 72: Whether the user presses the clear key is determined. If the answer is negative, Step 72 is repeated; otherwise, Step 721 is jumped to for setting this item of data to zero, and Step 73 is then jumped to.

Step 73: Whether the user keys in a piece of data is determined. If the answer is positive, Step 731 is jumped to for displaying the keyed-in data, and Step 76 is then jumped to; otherwise, Step 74 is jumped to.

Step 74: Whether the user presses the up or down inquiry key is determined. If the answer is positive, Step 741 is jumped to for clearing that item of data; otherwise, Step 75 is jumped to.

Step 75: Whether the user presses the mode key is determined. If the answer is negative, Step 721 is jumped back to; otherwise, Step 751 is jumped to for clearing this item of data and switching to the calculation mode.

Step 76: Whether presses the up or down inquiry key is determined. If the answer is positive Step 761 is jumped to for confirming that item of data; otherwise, Step 77 is jumped to.

Step 77: Whether the user presses the mode key is determined. If the answer is negative, Step 731 is jumped back to; otherwise, Step 771 is jumped to for confirming this item of data and switching to the calculation mode.

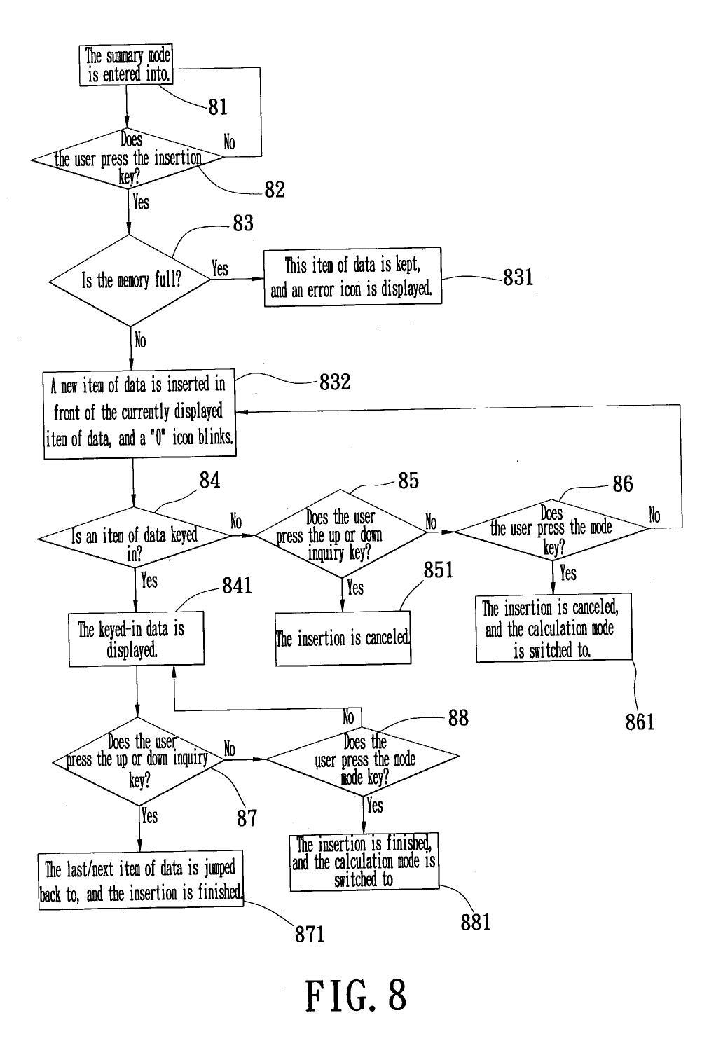

FIG. 8 is a flowchart for inserting items of the present invention.

Step 81: The summary mode is entered into.

Step 82: Whether the user presses the insertion key is determined. If the answer is negative, Step 81 is jumped back to; otherwise, Step 83 is jumped to

Step 83: Whether the memory is full is determined. If the answer is positive, Step 831 is jumped to for keeping this item of data and displaying an error icon; otherwise, Step 832 is jumped to for inserting a new item of data in front of the currently displayed item of data and blinking the “0” icon, and Step 84 is then jumped to.

Step 84: Whether an item of data is keyed in is determined. If the answer is positive, Step 841 is jumped to for displaying this item of data, and Step 87 is then jumped to; otherwise, Step 85 is jumped to.

Step 85: Whether the user presses the up or down inquiry key is determined. If the answer is positive, Step 851 is jumped to for canceling the insertion; otherwise, Step 86 is jumped to.

Step 86: Whether the user presses the mode key is determined. If the answer is positive, Step 861 is jumped to for canceling the insertion and switching to the calculation mode; otherwise, Step 832 is jumped back to.

Step 87: Whether the user presses the up or down inquiry key is determined.

If the answer is positive, Step 871 is jumped to for jumping back to the 15 last/next item of data and finishing the insertion; otherwise, Step 88 is jumped to.

Step 88: Whether the user presses the mode key is determined. If the answer is positive, Step 881 is jumped to for finishing the insertion and switching to the calculation mode; otherwise, Step 841 is jumped back to.

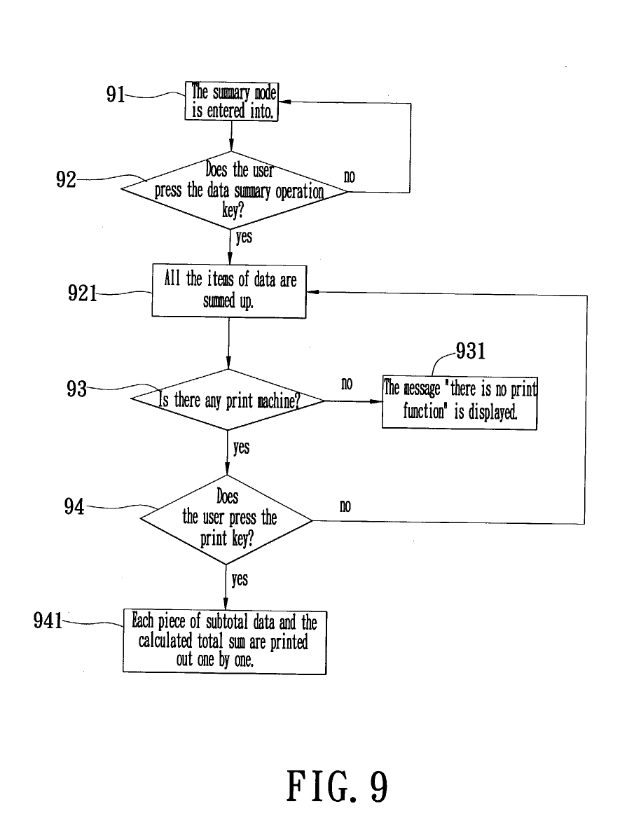

FIG. 9 is a flowchart for data summary and print of the present invention.

Step 91: The summary mode is entered into.

Step 92: Whether the user presses the data summary operation key is determined. If the answer is negative, Step 91 is jumped back to; otherwise, Step 921 is jumped to for summing up all the data and displaying the result on the screen, and Step 93 is then jumped to.

Step 93: Whether there is a print machine is determined. If the answer is negative, Step 931 is jumped to for displaying the message “there is no print function”; otherwise, Step 94 is jumped to.

Step 94: Whether the user presses the print key is determined. If the answer is negative, Step 921 is jumped back to; otherwise, Step 941 is jumped to for printing each piece of subtotal data one by one and the calculated total sum.

To sum up, through the added summary function of the present invention, the user can have both the functions of accounts check and surplus calculation with the memory space used most economically, hence enhancing the convenience of use.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A method having a summary function for a calculator, said method letting said calculator having both functions of accounts check and surplus calculation, said method comprises the steps of:
(a) selecting desired items of data and storing said items of data into a memory; and
(b) entering into a summary mode to check each piece of subtotal data one by one for use of accounting or to sum up each piece of data in said memory;

2. The method having a summary function for a calculator as claimed in claim 1, wherein a key can be used to record a currently displayed data into said memory, and a summary icon will be displayed on a screen to represent there is data in said memory in said Step (b).

3. The method having a summary function for a calculator as claimed in claim 1, wherein a mode key can be used to selectively enter into said summary mode in said Step (b).

4. The method having a summary function for a calculator as claimed in claim 1, wherein each piece of data can be looked up in said summary mode of said Step (b).

5. The method having a summary function for a calculator as claimed in claim 1, wherein a displayed data can be cleared in said summary mode of said Step (b).

6. The method having a summary function for a calculator as claimed in claim 1, wherein an item of data can be inserted in front of a displayed item of data, and said item of inserted data will be recorded into said memory when leaving said item of data or directly leaving said summary mode after data input is finished in said summary mode of said Step (b).

7. The method having a summary function for a calculator as claimed in claim 1, wherein all recorded data can be summed up and the result will be displayed on a liquid crystal screen in said summary mode of said Step (b).

8. The method having a summary function for a calculator as claimed in claim 1, wherein each piece of subtotal data can be checked one by one for use of accounting of one day or one week, and each piece of subtotal data and a calculated total sum thereof can be printed out one by one.
